(19) United States
(12) Patent Application Publication
(10) Pub. No.: US 2005/0055216 A1
(43) Pub. Date: Mar. 10, 2005

(54) System and method for the automated collection of data for grammar creation

(75) Inventors: Robert R. Bushey, Cedar Park, TX (US); Benjamin A. Knott, Round Rock, TX (US); Theodore B. Pasquale, Austin, TX (US); Shannon D. Novak, Allen, TX (US); John T. Elliott, Dallas, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P., Reno, NV (US)

(21) Appl. No.: 10/655,437

(22) Filed: Sep. 4, 2003

(51) Int. Cl. G10L 15/00

(52) U.S. Cl. 704/277

(57) ABSTRACT

A system and method for automatically collecting data for grammar creation includes one or more receiving devices, a collection module, a speech recognition engine, and a routing module. The receiving device receives a plurality of inbound inquiries from customers while the collection module queries the customers for an opening statement including a customer task. The speech recognition engine recognizes the speech of the customers in the opening statements and analyzes the one or more recognized words in the speech of the customer. The routing module identifies the customer task from the recognized speech of the opening statement, determines the correct routing destination for the inbound inquiry based on the analysis of the recognized words, and automatically routes the inbound inquiry to the correct routing destination. The system and method further includes a tuning module that creates and modifies grammars that enable more accurate speech recognition.

### BACKGROUND OF THE INVENTION

Customers often call a company service call center or access a company's web page to perform a specific customer task such as change their address, pay a bill, alter their existing services, or receive assistance with problems or questions regarding a particular product or service. When calling, customers often speak to a customer service representative (CSR), also known as agents, or interact with an interactive voice response (IVR) system. Customers typically explain the purpose of the inquiry in the first statement made by the customers whether that be the first words spoken by the customers or the first line of text from a web site help page or an email. These statements made by the customers are often referred to as opening statements and are helpful in quickly determining the purpose of the customers' inquiry.

Because of the high costs associated with live agents, many companies are generally migrating from expensive CSRs to more cost effective automated IVR systems employing speech recognition in order to manage the expense associated with operating service call centers. In order to maintain a high level of customer satisfaction, the IVR systems utilizing speech recognition must quickly and correctly recognize the customer speech and aid customers in accomplishing their desired tasks.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a schematic diagram of an example embodiment of a system for automated collection of data for grammar collection;

FIG. 2 illustrates a block diagram of an example grammar collection system; and

FIG. 3 depicts a flow diagram of an example embodiment of a method for automated collection of data for grammar collection.

### DETAILED DESCRIPTION OF THE INVENTION

Preferred embodiments of the present invention are illustrated in the figures, like numerals being used to refer to like and corresponding parts of the various drawings.

When customers call a customer service center or call center seeking to perform a customer task, the customers are increasingly interacting with an automated self-service application instead of a live agent due to the high costs associated with agent time. An automated self-service application is a system consisting of a plurality of menus and user prompts designed and arranged in a hierarchical design. When calling a customer service number or accessing a customer service web site, the customer is generally greeted with an automated system asking the customer to supply such information as the customer's account number or telephone number. In one type of automated system, the customer is provided with one or more options arranged in a menu and the customer selects the option that most closely relates to the purpose for contacting the customer service center. For example, the automated self-service application may ask the customer if the customer would like to pay a bill, alter their service, change their address, or learn about new products and services. The customer responds to the menu prompt by either speaking the response if the automated self-service application utilizes speech recognition technology or by touch tone response by pressing the number keys on the telephone. The automated self-service application continues providing menu prompts to the customer and the customer continues responding to the menu prompts until the customer is able to complete the customer's task and then the customer exits the automated self-service application.

In more open-ended customer service systems, when a customer contacts a customer service center with a specific customer task, the customer provides an opening statement (typically the first substantive statement made by the customer) which includes the purpose for the customer contacting the service center. These opening statements can be used by companies to better design web sites, IVR systems, and any other customer interfaces between a company and the customers. One effective way to design an IVR system or a web site interface is to analyze the scripts of incoming calls or emails to a customer service center to locate the opening statements and identify the purpose of each call or email.

In typical customer service centers, the customer's call is routed to a specific agent or automated menu system based on the customer task which is generally gleamed from the opening statement. When first contacting the customer service center, the customer is greeted by an automated prompt asking the customer for the purpose of the customer's inquiry. In response to the prompt the customer provides an opening statement. Unbeknownst to the customers, an agent at the customer service center is listening in the background for the opening statement so that the agent can correctly route the customer's call. In this manner, the agent acts as a so-called wizard agent recording, storing, and analyzing the customer's opening statement to determine the customer task and the corresponding correct routing destination all while never speaking to the customer. Once the wizard agent has determined the customer task by examining the opening statement, the wizard routes the customer's call to the correct routing location, whether it be a live agent or an automated system, based on the customer task. The wizard agents log all the data from the calls.

The wizard agents use a set of rules to determine where to route the calls. For example, the wizard agent may route a customer having an opening statement of “I want to pay my bill” to the automated bill paying system and another customer having an opening statement of “I have a bill dispute” to a live agent. Once the wizard agent routes the customer's call, the wizard agent records the opening statement and the associated routing destination. After the wizard agents have collected a large amount of opening statements and associated routing destinations, the recorded opening statements and routing destinations can be manually analyzed to create and tune grammars to enable speech recognition based on the speech of the customers.

Using wizard agents to route calls and store opening statements is an expensive process. The process occupies a large amount of an agent's time and is therefore expensive because of the high cost of agent time. For example, a wizard agent may spend eight minutes for each call if the policy is to listen to the entire call. If the wizard agent reduces involvement to routing and data gathering, the wizard agent may spend two minutes on each call. Given that the typical cost for an agent's time is $3.00/minute, wizard agent time can quickly become cost prohibitive. In addition, having agents acting as wizard agents instead of interacting with the customers prevents the agents from their normal job of helping the customers and performing other revenue generating tasks. Furthermore, call center managers are reluctant to free up agents to act as wizard agents because of the cost and associated lost time. In order to tune the grammars and speech recognition with new data, additional agents have to be used as wizard agents to gather the new data which is costly due to the agent time and the reopening of cases.

Utilizing wizard agents to collect data for the creation of grammars accumulates data at a relatively slow rate. Wizard agents are inherently limited in the amount of data that they can collect. Because wizard agents are limited in the amount of opening statements and related routing destinations they can collect, the rate of data accumulation for grammar collection and creation is very slow because a large amount of data is necessary for accurate analysis and grammar creation.

Furthermore, wizard agents are subject to human error and do not always route customers to the correct routing destination. When a customer is routed to an incorrect routing destination, the customer often becomes frustrated and dissatisfied. In addition, the use of wizard agents often increases the average time to answer each customer call because there are a limited number of wizard agents operating and able to answer customer calls. Therefore, customer hold times typically increase, resulting in an increase in customer dissatisfaction.

By contrast, the example embodiment described herein allows for the automatic collection of data for grammar creation. The example embodiment allows for the automated collection of customer opening statements, customer tasks, and routing destination data without the assistance of wizard agents. Because an automated system collects the data and routes the customer inquiries based on the analysis of data provided by the customers, a larger amount of data is able to be collected and analyzed. Therefore, grammar collection and creation is able to occur at a faster rate and with greater accuracy because of the increase in the amount of data. In addition, the grammars may quickly be modified with newly collected data. Time and money are saved because live agents are no longer required to operate as wizard agents and can therefore spend their time directly resolving customer issues. Also, holding times are reduced for the customers resulting in customers having a higher level of customer satisfaction. Furthermore, speech recognition capabilities improve because data may be continuously collected and analyzed thereby allowing for quicker and more accurate call routing based on the customer opening statements.

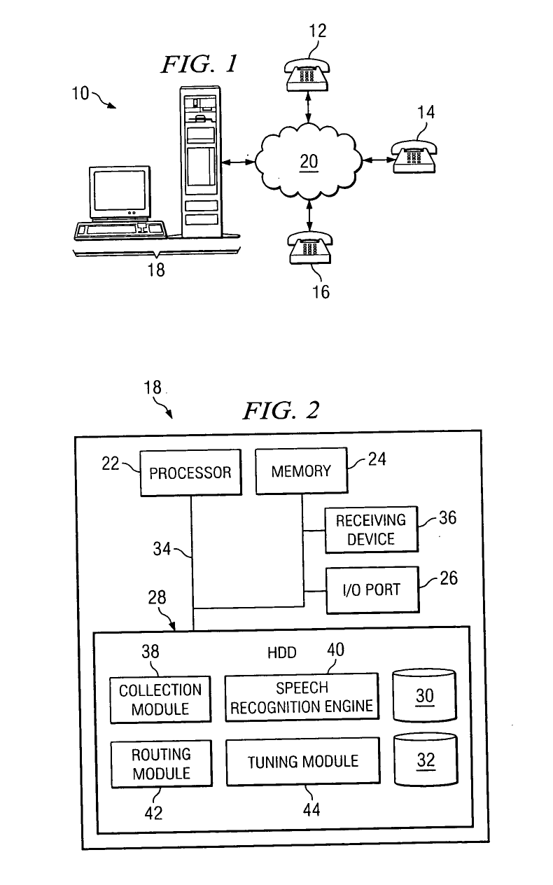

Referring now to FIG. 1, a schematic diagram of an example embodiment of a system for automated collection of data for grammar collection is depicted. Customer service system 10 includes three customer premise equipment 12, 14, and 16 and grammar collection system 18 with customer premise equipment 12, 14, and 16 in communication with customer feedback system 18 via network 20. Customer premise equipment (CPE), also known as subscriber equipment, include any equipment that is connected to a telecommunications network and located at a customer's site. CPEs 12, 14, and 16 may be telephones, 56k modems, cable modems, ADSL modems, phone sets, fax equipment, answering machines, set-top box, POS (point-of-sale) equipment, PBX (private branch exchange) systems, personal computers, laptop computers, personal digital assistants (PDAs), SDRs, other nascent technologies, or any other appropriate type or combination of communication equipment installed at a customer's or caller's site. CPEs 12, 14, and 16 may be equipped for connectivity to wireless or wireline networks, for example via a public switched telephone network (PSTN), digital subscriber lines (DSLs), cable television (CATV) lines, or any other appropriate communications network. In the example embodiment of FIG. 1, CPEs 12, 14, and 16 are shown and generally referred to as telephones, but in alternate embodiments may be any other appropriate type of customer premise equipment.

Telephones 12, 14, and 16 are located at the customer's premise. The customer's premise may include a home, business, office, or any other appropriate location where a customer may desire telecommunications services. Grammar collection system 18 is remotely located from telephones 12, 14, and 16 and is typically located within a company's customer service center or call center which may be in the same or a different geographic location as telephones 12, 14, and 16. The customers or callers interface with grammar collection system 18 using telephones 12, 14, and 16. The customers and telephones 12, 14, and 16 interface with grammar collection system 18 and grammar collection system 18 interfaces with telephones 12, 14, and 16 through network 20. Network 20 may be a public switched telephone network, the Internet, a wireless network, or any other appropriate type of communication network. Although only one grammar collection system 18 is shown in FIG. 1, in other embodiments grammar collection system 18 may serve alone or in conjunction with additional grammar collection systems located in the same customer service center or call center as grammar collection system 18 or in a customer service center or call center remotely located from grammar collection system 18. In addition, although three telephones 12, 14, and 16 are shown in FIG. 1, in other embodiments customer service system 10 may include more than three or less than three telephones.

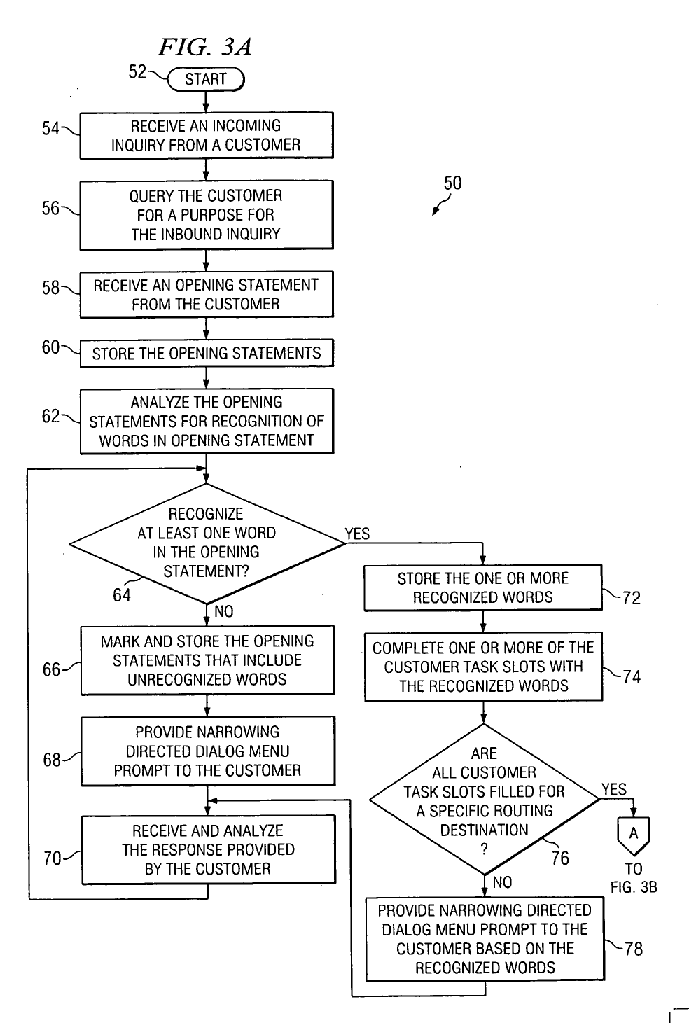

FIG. 2 illustrates a block diagram of grammar collection system 18 in greater detail. In the example embodiment, grammar collection system 18 may include respective software components and hardware components, such as processor 22, memory 24, input/output ports 26, hard disk drive (HDD) 28 containing databases 30 and 32, and those components may work together via bus 34 to provide the desired functionality. In other embodiments, HDD 28 may contain more than two or less than two databases. The various hardware and software components may also be referred to as processing resources. Grammar collection system 18 may be a personal computer, a portable computer, a server, or any other appropriate computing device with a network interface for communicating over networks such as telephone communication networks, the Internet, intranets, LANs, or WANs and located at a location remote from telephones 12, 14, and 16.

Grammar collection system 18 also includes receiving device 36 as well as collection module 38, speech recognition engine 40, routing module 42, and tuning module 44, which reside in memory such as HDD 28 and are executable by processor 22 through bus 34. Grammar collection system 18 may further include a text to speech (TTS) engine (not expressly shown). Speech recognition engine 40 and the TTS engine enable customer service system 10 to utilize a speech recognition interface with the customers on telephones 12, 14, and 16. The speech recognition engine 40 allows grammar collection system 18 to recognize the speech or utterances provided by the customers in response to one or more prompts while the TTS engine allows grammar collection system 18 to playback to the customers in prompts variable data, such as data returned from a database search. [Note to inventors—should the TTS engine be included in FIG. 2?]

Receiving device 36 communicates with I/O ports 26 via bus 34 and in other embodiments there may be more than one receiving device 36 in grammar collection system 18 and customer service system 10. One such type of receiving device is an automatic call distribution system (ACD) that receives plural inbound telephone calls and then distributes the inbound telephone calls to agents or automated systems. Another type of receiving device is a voice response unit (VRU) also known as an interactive voice response system (IVR). When a call is received by a VRU, the caller is generally greeted with an automated voice that queries the caller for information and then routes the call based on the information provided by the caller. When inbound telephone calls are received, typically VRU and ACD systems employ identification means to collect caller information such as automated number identification (ANI) information provided by telephone networks that identify the telephone number of the inbound telephone call. In addition, VRUs may be used in conjunction with ACDs to provide customer service.

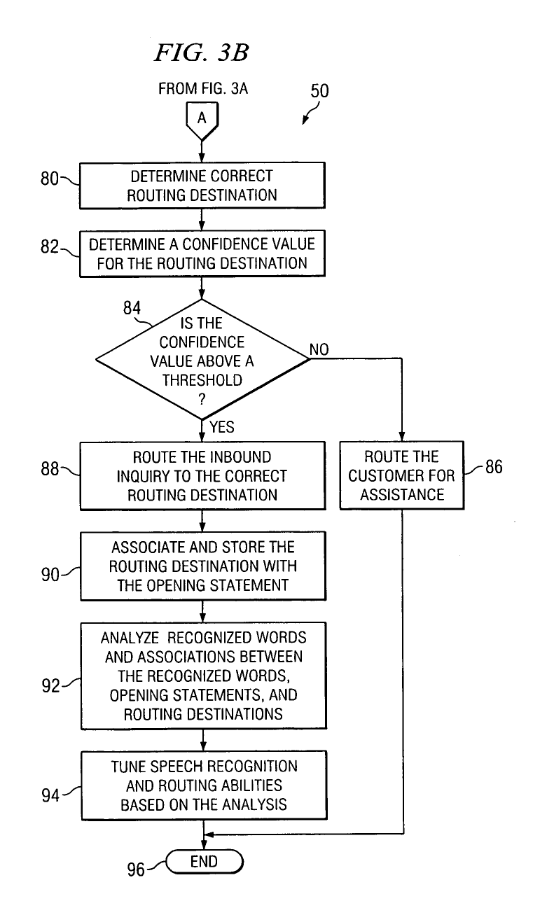

FIG. 3 illustrates a flow diagram of one embodiment of a method for the automated collection of data for grammar collection. The method allows for the automated collection of data regarding customer tasks which can then be utilized in creating and tuning grammars for speech recognition. Method 50 begins at step 52 and at step 54 receiving device 36 receives an inbound inquiry from a customer where the customer uses telephone 12, 14, or 16 to contact grammar collection system 18. The inbound inquiry may be a telephone call, a voice message, an email, or any other appropriate type of inquiry. At step 56 collection module 38 queries the customer for the customer task or the purpose of the inbound inquiry. Collection module 38 provides an automated menu prompt to the customer. The automated menu prompt may be in the form of an open-ended question such as “Thank you for contacting XYZ Company. What do you want to do today,” “What task would you like to accomplish today,” or any other appropriate type of open-ended question that solicits from the customer the purpose of the inbound inquiry. In response to the open-ended question, the customer speaks a response or opening statement that conveys the purpose of the inbound inquiry. Such an opening statement may be “I want to pay my bill,” “I need to change my address,”, “I want to cancel my service,” or any other response conveying a customer task. At step 58 collection module 38 receives the opening statement from the customer and stores the opening statement in database 30 at step 60.

After collection module 38 receives and stores the opening statement, at step 62 speech recognition engine 40 analyzes the opening statement in an attempt to recognize the speech of the customer in the opening statement. Speech recognition engine 40 utilizes conventional speech recognition techniques when recognizing the speech of the customer. When recognizing the speech of the customers, speech recognition engine 40 may ignore certain words that provide no substantive information regarding the purpose of the call. For example, with an opening statement of “I want to pay my bill,” speech recognition engine 40 may ignore “I want to” since those three words provide no substantive information regarding the customer task and because the majority of opening statements begin with “I want to . . . ”. At step 64, speech recognition engine 40 determines if it recognizes at least one word in the opening statement.

In addition to recognizing the words in the opening statement, speech recognition engine 40 also determines a confidence value regarding the recognition of speech. For instance, speech recognition engine 40 may recognize the word “bill” but only be 50% confident that the recognition is correct. Furthermore, speech recognition engine 40 may also recognize the word “pay” and be 90% confident in the recognition of “pay.” In order for speech recognition engine 40 to successfully recognize a word, speech recognition engine 40 must recognize a word with a confidence value over a set threshold. For instance, that threshold may be set at 80% so that if speech recognition engine 40 is not at least 80% confidence in the speech recognition, speech recognition engine 40 does not consider the word to be recognized. The threshold can be set any desired level but may typically be set at 70% or higher.

If at step 64 speech recognition engine 40 does not recognize at least one of the substantive words in the opening statement or if the confidence value for the speech recognition is below the set threshold value, method 50 continues to step 66 where collection module 38 marks and stores the opening statement in database 30 as including unrecognized words. Because speech recognition engine 40 did not recognize any of the words in the opening statement at step 64, grammar collection system 18 cannot determine the purpose or customer task for the inbound inquiry.. Therefore, grammar collection system 18 must ask the customer additional questions in order to determine the customer task and therefore properly route the inbound inquiry.

At step 68 collection module 38 begins a directed dialog with the customer to determine the purpose or customer task of the inbound inquiry. The directed dialog may be a single question or a series of questions that gradually become more narrow and are asked of the customer thereby enabling grammar collection system 18 to determine the customer task for the inbound inquiry. When collection module 38 asks the questions of the customer, at step 70 speech recognition engine 40 receives and analyzes the customer's responses in order to determine the purpose of the inbound inquiry. Steps 68 and 70 may occur one question at a time or may occur as a series questions before returning to step 64. For example, collection module 38 may ask a directed dialog question at step 68, receive the response at step 70, and speech recognition engine 40 analyzes the response at step 70 and then method 50 returns to step 64 where speech recognition engine 40 determines if it recognizes any of the words in the response provided by the customer in response to the question asked at step 68. If speech recognition engine 40 still does not recognize any of the speech, then steps 66, 68, and 70 are repeated until speech recognition engine 40 recognizes at least one substantive word at step 64.

If at step 64 speech recognition engine 40 recognizes at least one word, at step 72 speech recognition engine 40 stores the one or more recognized words in a database such as database 30 or 32. Once the recognized words have been stored, at step 74 routing module 42 takes the recognized words and attempts to fill one or more customer task slots of a plurality of customer task slot combinations with the recognized words. Each customer task is associated with a specific customer task slot combination. A customer task slot combination consists of one or more customer task slots where each slot is a word. Typically a customer task slot combination is two customer task slots where one slot is for an action word such as a verb and another slot is for an object word such as a noun. But customer task slot combinations may have only one slot or more than two slots. For example, a customer task slot combination may be “pay, bill” which would be associated with the customer task of paying a bill, “order Call Waiting” for adding the call waiting feature to a telephone service, or “change address” for changing the address for where the customer receives service from the company.

Routing module 42 receives the recognized words from speech recognition engine 40 and places the recognized words in the customer task slots. After routing module 42 places the recognized words in the customer task slots, at step 76 routing module 42 determines if one customer task slot combination is completely filled with recognized words. If a customer task slot combination is completely filled with recognized words, then grammar collection system 18 has determined the customer task or purpose for the inbound inquiry and can correctly route the inbound inquiry. If a customer task slot combination is not completely filled or completed, then the customer task or purpose of the inbound inquiry has not been determined and the proper routing destination remains unknown.

If at step 76 there is not a complete customer task slot combination, then grammar collection system 18 requires additional information from the customer to correctly route the inbound inquiry and at step 78 collection module 38 enters into a narrowing directed dialog based on the recognized words with the customer to gather additional information regarding the customer task. For instance, the original opening statement spoken by the customer may have been “I have an invoice to pay.” Speech recognition engine 40 may have recognized the word “pay” at step 64 but not recognized “invoice.” Therefore, at step 74 routing module 42 placed “pay” into a customer task slot and then determined at step 76 that there was not a complete customer task slot combination. Therefore, collection module 38 asks the customer additional questions to determine the customer task using the recognized word “pay” as a basis of the questions. Collection module 38 may ask the customer, “Do you have a bill to pay” upon which at step 70 the customer would respond yes whereby method 50 repeats step 64 through step 76 where routing module 42 would be able to complete a customer task slot combination with “pay” and “bill” and then continue the method as described below.

If at step 76 routing module 42 is able to complete a customer task slot combination then at step 80 routing module 42 determines the correct routing destination for the inbound inquiry. Routing module 42 determines the correct routing destination based upon the completed customer task slot combination. Because each customer task slot combination is associated with a specific customer task and therefore a routing destination, when a customer task slot combination is completed with recognized words, the associated routing destination is the correct routing destination for the inbound inquiry.

At step 82 routing module 42 determines a confidence value for the routing destination determined at step 80 where the confidence value is based on the confidence value for the speech recognition of the words in the opening statements and any other statements provided by the customer as well as the placing of the recognized words in the customer task slots. Each customer task slot combination includes a threshold value for the confidence value for the customer task slot combination. If the confidence value is below the threshold then routing module 42 will not route the customer to the determined routing destination because there is a high risk that the determined routing destination is not the correct routing destination. At step 84 routing module 42 determines if the confidence value for the customer task slot combination is above the threshold. If the confidence value is below the threshold at step 84 then at step 86 routing module 42 routes the customer for assistance. Routing the customer for assistance may include routing the customer to a live agent, to step 68 so that the customer can engage in a narrowing directed dialog with collection module 38 to further clarify the customer task, or to any other appropriate routing destination where the customer can receive routing assistance.

If at step 84 the confidence value is above the threshold, routing module 42 routes the customer to the proper routing destination at step 88. In other embodiments, grammar collection system 18 may ask the customer a confirming question such as “Do you want to pay your bill” before routing the customer to the correct routing destination. The confirming question adds an additional level of certainty in insuring that the customer is routed to the correct routing destination based upon the customer task provided by the customer.

After routing module 42 routes the customer to the correct routing destination, at step 90 routing module 42 associates the opening statement with the correct routing destination and stores the opening statement, correct routing destination, and the association between the two in a database such as database 30 or 32. Once stored, at step 92 tuning module 44 analyzes the opening statements, the correct routing destinations, the recognized words, and the associations between the opening statements and associated routing destinations in order to improve the speech recognition capabilities of speech recognition engine 40 and the routing capabilities of routing module 42. The more words that are recognized and stored by speech recognition engine 40 during the initial opening statement phase and the directed dialog phase increases the number of words that can be initially recognized by speech recognition engine 40 so that the customers do not have to engage in the directed dialog in order for grammar collection system 18 to determine the customer tasks. Furthermore, the associations between the opening statements, customer task slot combinations and routing destinations allows for more accurate routing of the inbound inquiries at higher confidence levels by routing module 42. The analysis of the opening statements, the correct routing destinations, the recognized words, and the associations between the opening statements and associated routing destinations allows for tuning module 44 to further tune and improve grammar collection system 18 at step 94 so that speech recognition engine 40 can continually recognize more words at higher confidence levels and routing module 42 can correctly place the recognized words in the customer task slots allowing for more accurate inbound inquiry routing.

It should be noted that the hardware and software components depicted in the example embodiment represent functional elements that are reasonably self-contained so that each can be designed, constructed, or updated substantially independently of the others. In other embodiments, however, it should be understood that the components may be implemented as hardware, software, or combinations of hardware and software for providing the functionality described and illustrated herein. In other embodiments, systems incorporating the invention may include personal computers, mini computers, mainframe computers, distributed computing systems, and other suitable devices.

Other embodiments of the invention also include computer-usable media encoding logic such as computer instructions for performing the operations of the invention. Such computer-usable media may include, without limitation, storage media such as floppy disks, hard disks, CD-ROMs, DVD-ROMs, read-only memory, and random access memory; as well as communications media such as wires, optical fibers, microwaves, radio waves, and other electromagnetic or optical carriers.

In addition, one of ordinary skill will appreciate that other embodiments can be deployed with many variations in the number and type of devices in the system, the communication protocols, the system topology, the distribution of various software and data components among the hardware systems in the network, and myriad other details without departing from the present invention.

Although the present invention has been described in detail, it should be understood that various changes, substitutions and alterations can be made hereto without departing from the spirit and scope of the invention as defined by the appended claims.

1. A method for automated grammar collection for the improvement of speech recognition, the method comprising:
receiving one or more inbound inquiries from one or more customers;
querying the customer for a customer task for the inbound inquiry by asking the customer an open-ended question;
receiving from the customer one or more opening statements, each opening statement including one or more customer tasks associated with the inbound inquiry;
storing the one or more opening statements in a database;
associating a plurality of routing destinations with one or more customer task slots with each routing destination having a unique customer task slot combination;
recognizing one or more of words in the opening statements utilizing speech recognition in order to determine the customer task;
storing the recognized words and one or more unrecognized words in a database;
determining a confidence value for the speech recognition of each of the recognized words in the opening statement;
asking the customer one or more directed dialog questions if the confidence value for one or more of the recognized words is below a threshold;
asking the customer one or more directed dialog questions if the there are one or more unrecognized words;
placing the recognized words having a confidence value above the threshold in one or more corresponding customer task slots until filling one of the unique customer task slot combinations with recognized words;
routing the inbound inquiry to the routing destination associated with the filled customer task slot combination;
creating an association between the routing destination associated with the filled customer task slot combination and the opening statement;
storing the routing destination for the inbound inquiry and the association between the routing destination and the opening statement in a database;
utilizing the recognized words in the opening statements to build one or more grammars to facilitate speech recognition;
analyzing the opening statements, the routing destinations, and the association between the routing destinations and the opening statements; and
tuning a plurality of speech recognition capabilities using the analysis of the opening statements, the routing destinations, and the association between the routing destinations and the opening statements.

2. A method for automatically collecting and utilizing a plurality of grammars, the method comprising
receiving one or more inbound inquiries from one or more customers;
querying the customer for an opening statement including a customer task for the inbound inquiry;
recognizing one or more words in the opening statement utilizing a speech recognition application;
analyzing the recognized words in the opening statement;
identifying the customer task from the opening statement;
determining a correct routing destination for the inbound inquiry based on the analysis of the opening statement and the customer task;
automatically routing the inbound inquiry to the correct routing destination;
analyzing each opening statement and each associated correct routing destination; and
tuning the speech recognition application using the analysis of the opening statements and each associated correct routing destination.

3. The method of claim 2 wherein querying the customer comprises asking the customer an open-ended question regarding a purpose for the inbound inquiry.

4. The method of claim 2 further comprising utilizing the recognized words in the opening statements to build one or more grammars to facilitate speech recognition.

5. The method of claim 2 wherein analyzing the recognized words in the opening statement comprises associating a plurality of routing destinations with one of a plurality of customer task slot combinations where each customer task slot combination includes one or more customer task slots.

6. The method of claim 5 wherein determining the correct routing destination comprises placing the recognized words having a confidence value above a threshold in one or more of the customer task slots associated with the routing destinations until filling one of the customer task slot combinations with recognized words.

7. The method of claim 6 further comprising routing the inbound inquiry to the routing destination associated with the filled customer task slot combination.

8. The method of claim 2 further comprising providing to the customer a directed dialog in response to receiving one or more unrecognized words in the opening statement.

9. The method of claim 2 further comprising storing the correct routing destination for the inbound inquiry and an association between the correct routing destination and the opening statement in a database.

10. The method of claim 2 wherein tuning the speech recognition application comprises training the speech recognition application to recognize one or more different combinations of the words in the opening statement based on an order of the words within the opening statement.

11. The method of claim 2 wherein tuning the speech recognition application comprises utilizing the words in the opening statement to increase the number of words recognized by the speech recognition application.

12. A automated grammar collection system, the system comprising:
one or more receiving devices operable to receive a plurality of inbound inquiries from one or more customers;
a collection module associated with the receiving device, the collection module operable to query the customers for one or more opening statements including one or more customer tasks;
a speech recognition engine associated with the collection module, the speech recognition engine operable to recognize one or more words in the opening statements and analyze the recognized words in the opening statements; and
a routing module associated with the speech recognition engine, the routing module operable to identify the customer task from the opening statement, determine a routing destination for the inbound inquiry based on the analysis of the opening statement, and automatically route the inbound inquiry to the routing destination.

13. The system of claim 12 further comprising one or more databases operable to store the opening statements, the recognized words, the routing destinations, and an association between the opening statements and the routing destinations.

14. A system of claim 12 further comprising the speech recognition engine operable to determine a confidence value for the speech recognition of each of the words in the opening statements.

15. The system of claim 14 further comprising the collection module operable to present to the customer a directed dialog if the confidence value for one or more of the words is below a threshold.

16. The system of claim 12 further comprising the collection module operable to ask the customer one or more direct dialog questions when the speech recognition engine recognizes no words in the opening statement.

17. The system of claim 12 further comprising the collection module operable to provide to the customer a directed dialog when there are one or more unrecognized words in the opening statement.

18. The system of claim 12 further comprising a tuning module associated with the speech recognition engine, the tuning module operable to analyze each opening statement and an associated routing destination.

19. The system of claim 18 wherein the tuning module is further operable to train the speech recognition engine to recognize one or more different combinations of the words in the opening statement.

20. The system of claim 18 wherein the tuning module is further operable to utilize the words in the opening statements to increase the number of words recognized by the speech recognition engine.
